(19) United States
(12) Patent Application Publication
(10) Pub. No.: US 2008/0277830 A1
(43) Pub. Date: Nov. 13, 2008

(54) Apparatus for Transferring Doses of Plastics to the Dies of a Compression Moulding Machine

(75) Inventors: Alessandro Balboni, Granarolo dell'Emilia (BO) (IT); Matteo Camerani, Russi (RA) (IT); Fiorenzo Parrinello, Medicina (BO) (IT); Zeno Zuffa, Borgo Tossignano (BO) (IT)

Correspondence Address: NIXON & VANDERHYE, PC, 901 NORTH GLEBE ROAD, 11TH FLOOR, ARLINGTON, VA, 22203, US

(73) Assignee: SACMI COOPERATIVA MECCANICI IMOLA SOCIETA' COOPERTIVA, Imola (IT)

(21) Appl. No.: 12/090,904

(22) PCT Filed: Oct. 10, 2006
(86) PCT No.: PCT/EP2006/067218

§ 371 Date: Jul. 2, 2008

(30) Foreign Application Priority Data
Oct. 21, 2005 (IT) MO2005A000275

(51) Int. Cl. B29C 31/04; B29C 43/34

(52) U.S. Cl. 264/325; 425/397; 425/352

(57) ABSTRACT

An apparatus comprising a forming arrangement that is movable along a path for compression moulding of doses of plastics, a transferring device for transferring the doses to the forming arrangement, a liquid cooling arrangement for cooling the transferring device, an arm arrangement associated with the transferring device for moving the transferring device along a further path having a portion substantially coinciding with a further portion of said path.

This application is the U.S. national phase of International Application No. PCT/EP2006/067218 filed 10 Oct. 2006 which designated the U.S. and claims priority to Italian Application No. MO2005A000275 filed 21 Oct. 2005, the entire contents of each of which are hereby incorporated by reference.

The invention relates to apparatuses and a method for forming objects, in particular for obtaining preforms of containers by compression-moulding doses of plastics.

WO 03/047831 discloses an apparatus for compression moulding of doses of plastics so as to obtain preforms, comprising a supply device for supplying molten plastics, a moulding device for compression moulding of doses of said molten plastics and a transferring carousel for transferring the doses from the supplying device to the moulding device.

The supplying device comprises a fixed plate in the thickness of which one or more conduits are obtained that take the plastics coming from a plasticising cylinder to a rotating joint. The transferring carousel is positioned above the fixed plate and can rotate around a vertical axis. The transferring carousel supports a plurality of cylindrical chambers that extend around respective vertical axes. Each cylindrical chamber is provided with an open lower end and with a piston that can run inside the chamber parallel to the axis of the latter.

When a cylindrical chamber passes above the fixed plate, a dose of plastics coming from the rotating joint enters the cylindrical chamber through the open lower end thereof and pushes upwards the piston housed in the cylindrical chamber. The latter is then moved by the rotatable carousel along a circular path until it is above a die cavity of the moulding device. When this occurs, the piston is driven downwards and pushes the dose outside the cylindrical chamber through the lower open end. The dose is thus deposited in the die cavity underneath.

The apparatus disclosed in WO 03/047831 further comprises heat conditioning means provided with thermostatic water cooling circuits that cools and controls the temperature of the walls of the cylindrical chamber and of the piston head. The thermal conditioning means enables the adhesion to the cylindrical chamber and to the piston of the plastics constituting the dose to be reduced.

A drawback of the apparatus disclosed in WO 03/047831 is that when a cylindrical chamber and an underlying die cavity move away from one another, the dose has not completely entered the die cavity. In fact, the dose can be transferred to the die cavity only when the cylindrical chamber inside which the dose is received is above the corresponding cavity, which occurs only at a point of the circular path of the cylindrical chamber. It is therefore possible, particularly when relatively large doses of the type used for moulding preforms are processed, that the dose is unable to descend completely into the die cavity in the short time in which the latter is below the cylindrical chamber. If this occurs, it is necessary to stop the apparatus to remove the dose that has not been transferred correctly.

In order to eliminate this drawback, in the apparatus according to WO 03/047831, slidable pistons were introduced inside the cylindrical chambers to push the doses outside the chambers. Nevertheless, this has entailed a significant complication in the apparatus, inasmuch as precise coupling is required between the pistons and the cylindrical chambers and a movement device that moves, at the correct moment, each piston.

Another drawback of the apparatus disclosed in WO 03/047831 is that the latter has rather a complicated structure that may have significant encumbrance. In fact, to house both the moulding device and the supplying device below the transferring carousel, it is necessary for the transferring carousel to have a great diameter, so as to prevent interference between the moulding device and the supplying device. To move a transferred carousel having a great diameter, it is nevertheless necessary to overcome forces of inertia. Further, large spaces have to be available for installing the apparatus.

WO 2005/007378 discloses a method and a device for continuously supplying drops of molten synthetic resin for molding a molded product into a rotatingly moving molding female dies. The drops are formed by cutting the molten synthetic resin extruded from an extrusion opening part. The drops are held by a holding mechanism and are forcibly inserted into a molding female die recessed part. The holding mechanism, on a rotatingly moving type drop supply body, is moved close to the rotating molding die to match the rotating route of the holding mechanism with that of the molding die in a specified area to follow up the movement of the holding mechanism to the movement of the molding die.

An object of the invention is to improve the apparatuses and methods for forming objects, particularly by means of compression moulding of doses of plastics.

Another object is to make it easier to transfer the doses of plastics to a forming arrangement in which these doses are compression-moulded.

A further object is to decrease the overall dimensions of the apparatuses to form objects and to simplify the structure thereof.

A still further object is to reduce the force of inertia acting on the components of the apparatuses for forming objects.

In a first aspect of the invention, there is provided an apparatus comprising:
a forming arrangement that is movable along a path for compression moulding of doses of plastics;
a transferring device for transferring said doses to said forming arrangement;
a liquid cooling arrangement for cooling said transferring device;
an arm arrangement associated with said transferring device for moving said transferring device along a further path having a portion substantially coinciding with a further portion of said path.

Owing to this aspect of the invention, a relatively long time is made available for transferring the doses from the transferring device to the forming arrangement. In fact, the paths of the transferring device and of the forming arrangement, rather than having a single point in common as in the prior art, have respectively substantially coinciding portions, along which the dose can be transferred to the forming arrangement. This enables the risk to be reduced significantly that when the forming arrangement and the transferring device move away from one another, the dose has not yet completely entered the forming arrangement.

Further, owing to the liquid cooling arrangement, it is possible to keep the temperature of the transferring device limited, which enables the adhesion of the dose to the transferring device to be limited. This reduces the amount of time that is necessary for the dose to pass from the transferring device to the forming arrangement.

Owing to these solutions, it is possible to avoid using the pistons disclosed in WO 03/047831, which enables the structure of the apparatus to be simplified.

In a second aspect of the invention, there is provided an apparatus comprising:
a forming arrangement for compression moulding of doses of plastics;
a transferring device for transferring said doses from a delivery device to said forming arrangement, said transferring device having a first opening and a second opening communicating together;
a liquid cooling arrangement for cooling said transferring device;
   wherein said delivery device and said forming arrangement are positioned on opposite sides of said transferring device, so that said doses can enter said transferring device through said first opening and leave said transferring device through said second opening.

Owing to this aspect of the invention, it is possible to obtain an apparatus having a simple structure and limited overall dimensions. In particular, by positioning the delivery device and the forming arrangement on opposite sides of the transferring device, a compact apparatus is obtained in which the dimensions of the transferring device can be reduced with respect to the known apparatuses. This also enables the forces of inertia acting on the transferring device to be reduced.

The liquid cooling arrangement further enables the adhesion of the doses to the transferring device to be reduced.

In a third aspect of the invention, there is provided a method comprising:
receiving doses of plastics in a transferring device cooled by a cooling liquid;
moving said transferring device for transferring said doses to a forming zone;
compression moulding said doses in said forming zone;
   wherein said doses enter said transferring device through a first opening and exit from said transferring device through a second opening that is distinct from said first opening.

Owing to the third aspect of the invention, it is possible to transfer the doses of plastics to the forming zone in a simple and compact manner.

The invention can be better understood and implemented with reference to the enclosed drawings, which illustrate some embodiments thereof by way of non-limitative example, in which:

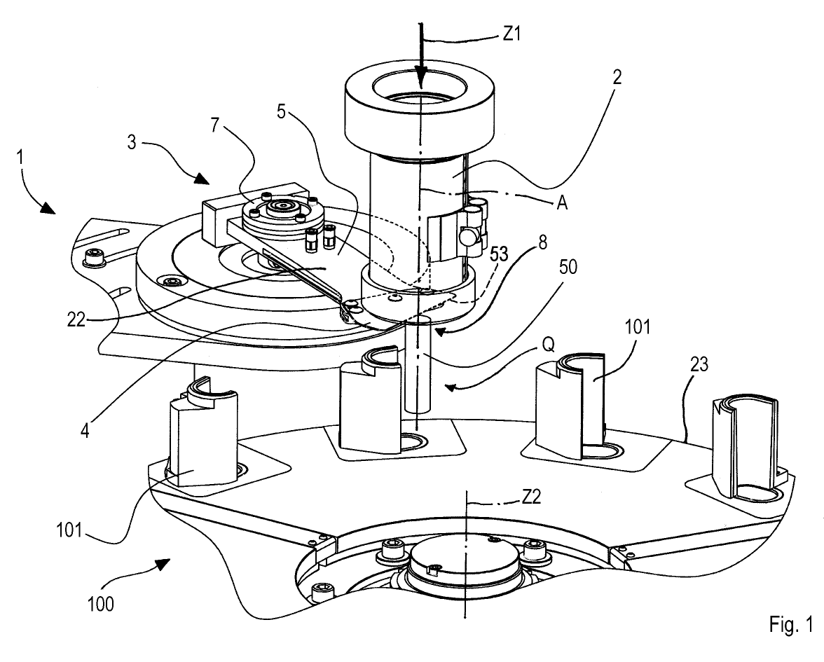

FIG. 1 is a perspective view of a portion of an apparatus for compression moulding of doses of plastics;

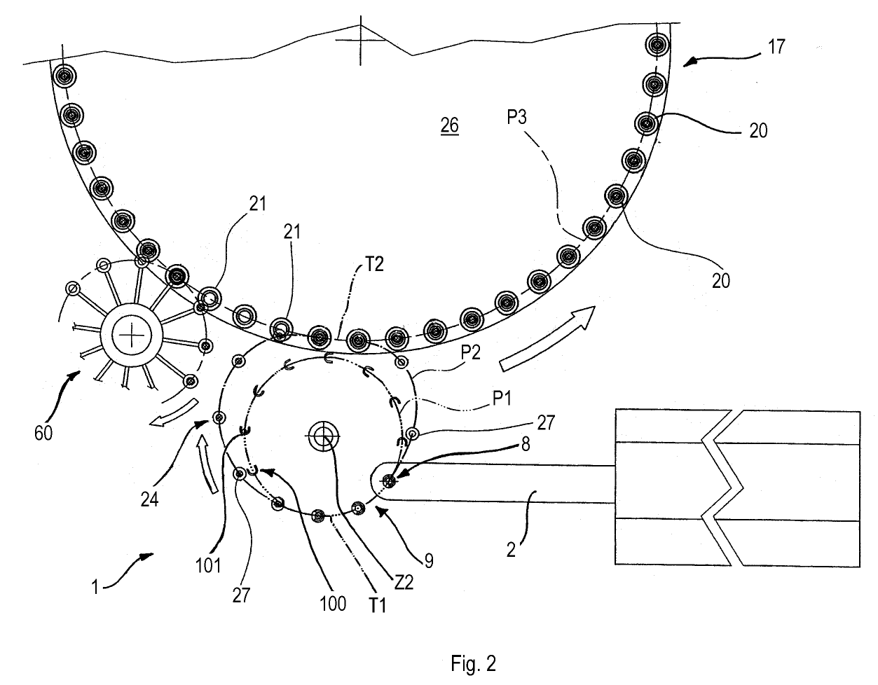

FIG. 2 is a plan view of the apparatus in FIG. 1;

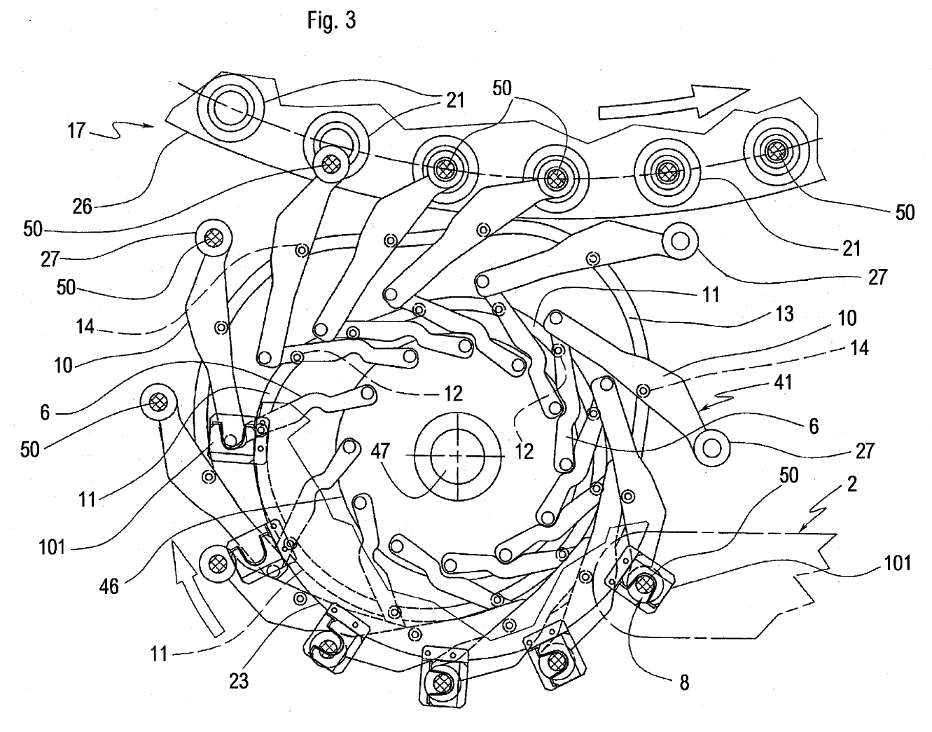

FIG. 3 is an enlarged and fragmentary view of an arm arrangement supporting a transferring device in the apparatus in FIG. 2;

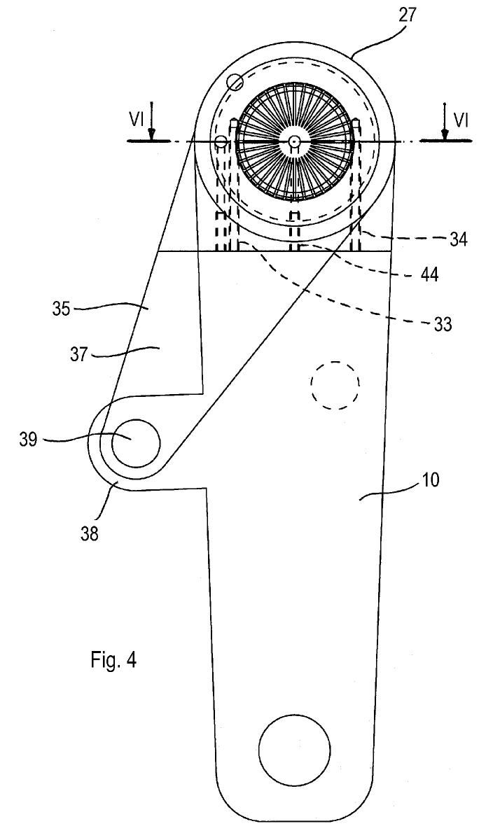

FIG. 4 is an enlarged plan view of the transferring device in FIG. 3, in a closed configuration;

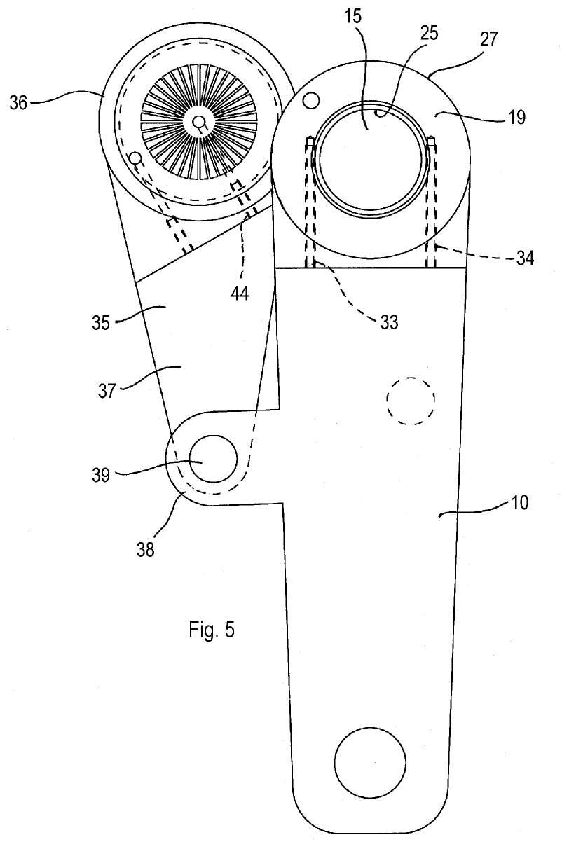

FIG. 5 is a view like the one in FIG. 4, showing the transferring device in an open configuration;

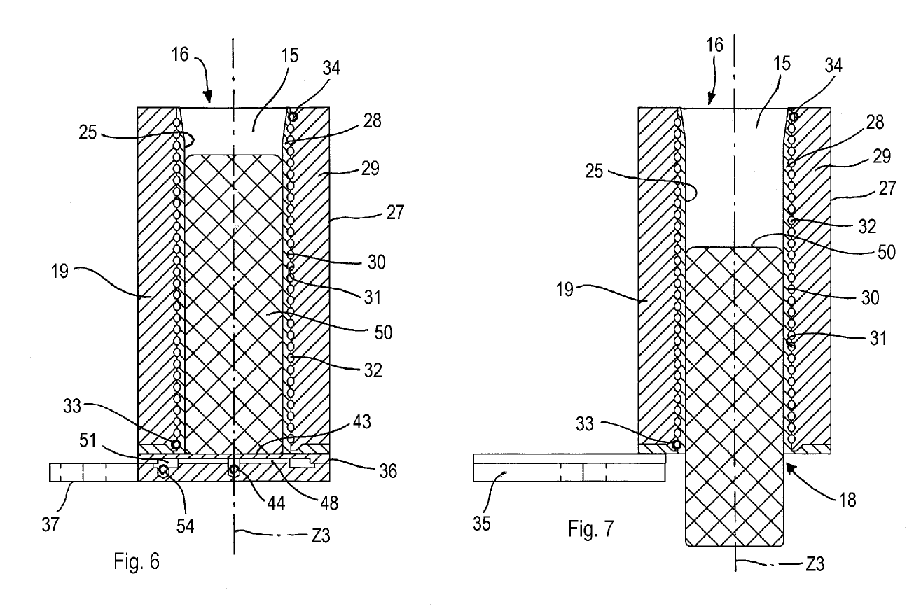

FIG. 6 is a section taken along the plane VI-VI in FIG. 4;

FIG. 7 is a section like the one in FIG. 6, in the open configuration;

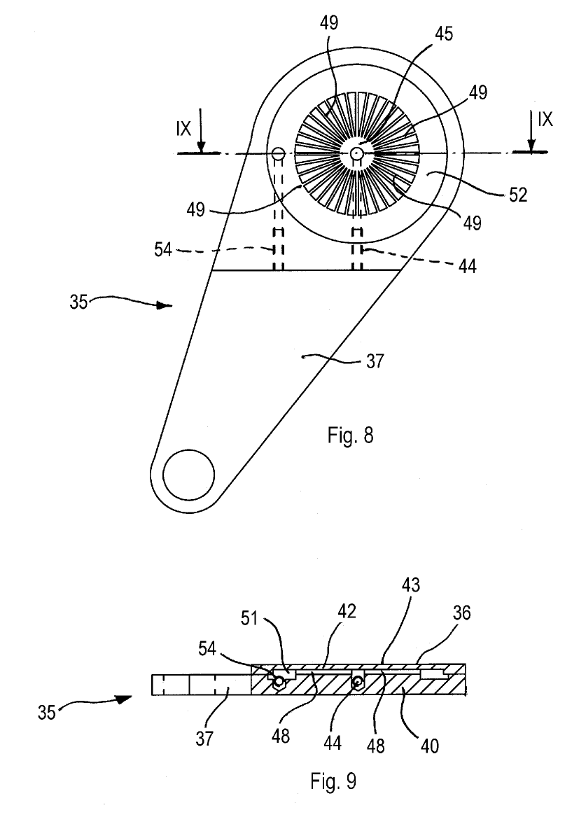

FIG. 8 is a plan view of a closing element of the transferring device in FIG. 4;

FIG. 9 is a section taken along the plane IX-IX of FIG. 8;

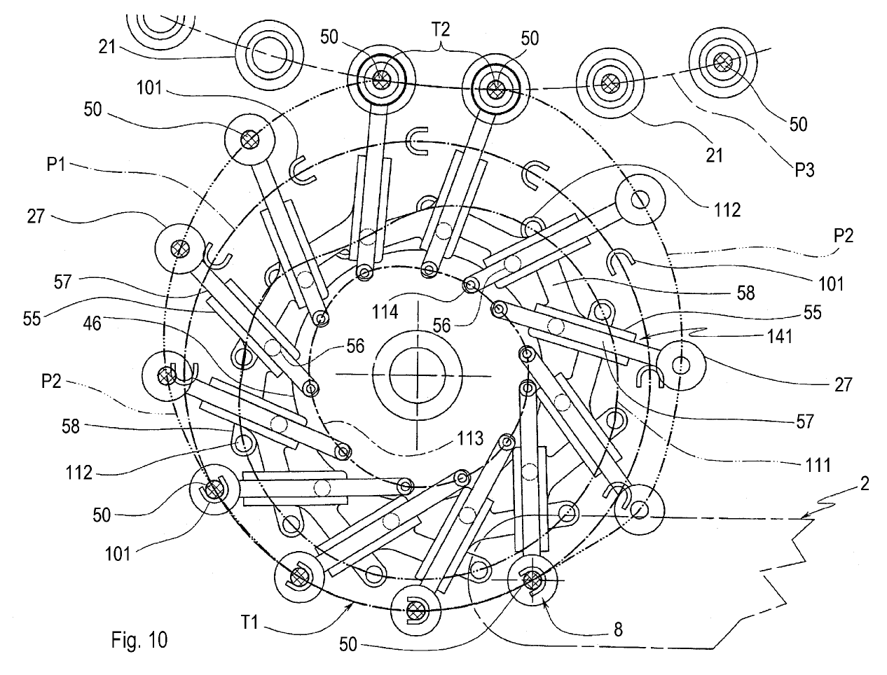

FIG. 10 is a plan view like the one in FIG. 3, showing an alternative embodiment of the arm arrangement;

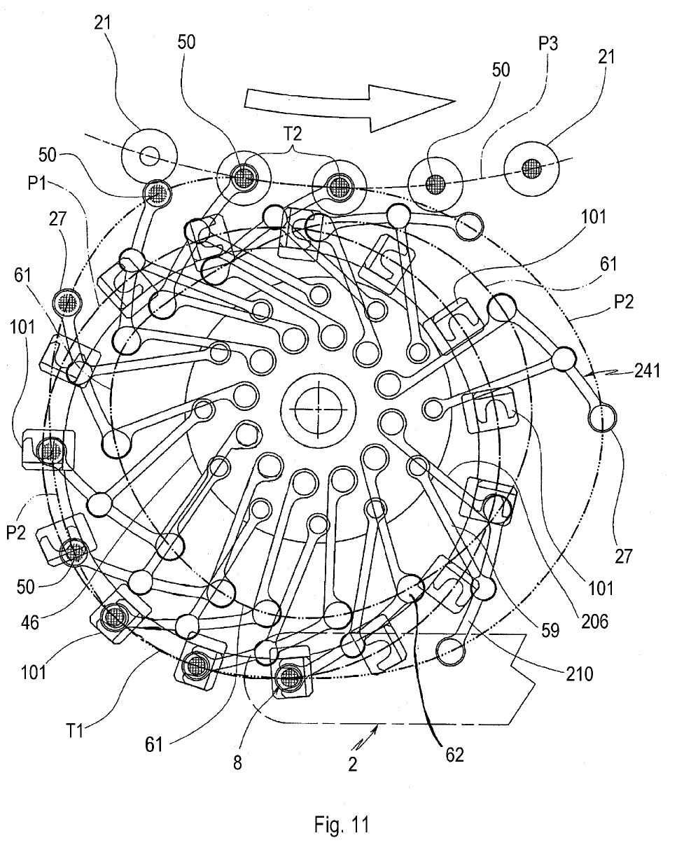

FIG. 11 is a plan view like the one in FIG. 3, showing a further alternative embodiment of the arm arrangement;

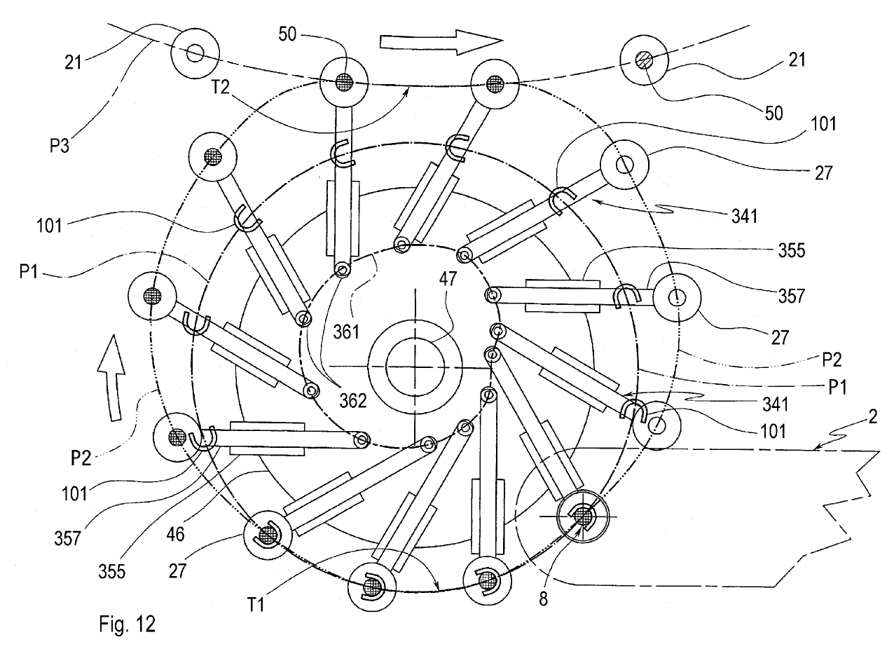

FIG. 12 is a plan view like the one in FIG. 3, showing a still further alternative embodiment of the arm arrangement.

With reference to FIGS. 1 and 2, there is shown an apparatus 1 for compression moulding of doses 50 of plastics so as to obtain objects, such as for example preforms for containers, particularly for bottles. The apparatus 1 comprises an extruding device 2 provided with a dispensing opening 8 through which the plastics are extruded along an outlet axis A arranged in an outlet direction Z1.

The apparatus 1 furthermore comprises a cutting arrangement 3 that cuts the plastics leaving the extruding device 2 to separate the doses 50 therefrom.

As shown in FIG. 1, the cutting arrangement 3 is provided with a knife 22 comprising a blade 4 supported by a support element 5. The blade 4 has a substantially flat geometry and is provided with a cutting edge 53 with a substantially rectilinear shape, that lies on the plane defined by the blade 4. The knife 22 is rotated by means of a rotating device 7 in such a way as to pass periodically below the extruding opening 8 to cut the plastics exiting from the extruding device 2.

Below the cutting arrangement 3 a transferring arrangement 9 is provided for transferring the cut doses 50 from the cutting arrangement 3 to a forming arrangement 17 comprising a plurality of moulds 20 mounted in a peripheral region of a moulding carousel 26. Each mould 20 comprises a die 21 and a punch, not shown, that are movable in relation to one another between an open position in which a dose 50 can be introduced inside the die 21 and a closed position in which the dose 50 is shaped so as to obtain a preform. The latter is extracted from the mould 20 by means of an extracting device 60.

The transferring arrangement 9 comprises a first transferring arrangement 100 comprising a first carousel 23 that is rotatable around a rotation axis Z2. In a peripheral region of the first carousel 23 there is mounted a plurality of first transferring elements 101 each of which has a “C”-shaped cross section and is provided with a concavity in which a dose 50 can be received. Below this concavity there is provided a funnel element that is not shown, by means of which the dose 50 can be transferred to a second transferring arrangement 24 of the transferring arrangement 9.

The second transferring arrangement 24 comprises a plurality of second transferring elements 27 each of which has the shape of a hollow cylinder.

The first transferring elements 101 are movable along a first substantially circular path P1 along which each first transferring element 101 receives a dose 50 cut from the cutting arrangement 3 in a removing position Q shown in FIG. 1. Whilst the first transferring element 101 moves along the first path P1, the dose 50 drops by gravity along the walls of the first transferring element 101 and after passing through the corresponding funnel element is delivered to a second transferring element 27.

The second transferring elements 27 are movable along a second path P2 that is at a lower level than the first path P1. The second path P2 is a closed and non circular loop path, in which it is possible to identify a first portion T1 in which the first path P1 is substantially coincident with the second path P2. Along the first portion T1, each first transferring element 101 moves by maintaining itself substantially superimposed on a corresponding second transferring element 27. In this way a relatively long period of time is made available in which the dose 50 contained in a first transferring element 101 can transfer into the corresponding second transferring element 27 due to the force of gravity.

After receiving the dose 50 from a superimposed first transferring element 101, each second transferring element 27 conveys the dose 50 along the second path P2 and releases it inside a die 21 underneath. The latter moves along a substantially circular third path P3 arranged at a lower level than the second path P2.

It is possible to identify a second portion T2 along which the second path P2 coincides substantially with the third path P3. In the second portion T2, each second transferring element 27 moves by maintaining itself substantially superimposed on a corresponding die 21. In this way a relatively long interval is made available during which the dose 50 can descend from the second transferring element 27 to the die 21 underneath. This ensures that the dose 50 is transferred completely into the die 21 before the latter moves away from the corresponding second transferring element 27.

In order to obtain the first portion T1 and the second portion T2, it is possible to provide a mechanism of the type shown in FIG. 3, comprising a circular support 46 that is rotatable around a shaft 47. The circular support 46 can be arranged on a horizontal plane, whilst the shaft 47 can be vertical on a fixed axis.

On the circular support 46 there is mounted a plurality of arm devices 41, each of which supports a respective second transferring element 27. Each arm device 41 is provided with two degrees of freedom with respect to the circular support 46 and, whilst it moves, is controlled by a first controlling device and by a second controlling device that enable the two degrees of freedom to be locked and the position of each second transferring element 27 to be determined univocally for each angular position of the circular support 46.

In particular, according to the embodiment illustrated in FIG. 3, each arm device 41 comprises a first arm 6 and a second arm 10. The first arm 6 has an end pivoted on the circular support 46 and a further end pivoted on the second arm 10. The latter supports, at a free end thereof, a second transferring element 27.

The first controlling device acts on the first arms 6, whilst the second controlling device acts on the second arms 10. The first controlling device comprises a first cam having a first track 11, in which first driven elements engage, comprising for example first rollers 12 carried by the first arms 6. Similarly, the second controlling device comprises a second cam having a second track 13, in which second driven elements engage comprising for example second rollers 14 carried by the second arms 10. Owing to the first controlling device and to the second controlling device, the movement of the second transferring elements 27 during each revolution of the circular support 46 is defined univocally.

In particular, by suitably designing the first track 11 and the second track 13, it is possible to obtain the first portion T1 and the second portion T2 along the second path P2.

As shown in FIGS. 4 and 6, each second transferring element 27 is mounted at a free end of a corresponding second arm 10 and has a tubular shape, for example like a hollow cylinder. Each second transferring element 27 comprises a side wall 19 having an internal surface 25 that bounds a chamber 15 in which the dose 50 can be received. In the shown example, the chamber 15 has a substantially cylindrical shape and extends along a vertical axis Z3. The chamber 15 has an upper opening 16, by means of which a dose 50 can enter the chamber 15 from a first transferring element 101, and a lower opening 18, by means of which the dose 50 can exit the chamber 15 to be transferred to a die 21 underneath.

The side wall 19 comprises an internal tubular element 28 arranged inside an external tubular element 29. The internal tubular element 28 is bounded internally by the internal surface 25 and is provided externally with a channel 30 that extends in the shape of a helix around the axis Z3. Inside the external tubular element 29 there is obtained a further channel 31 that extends as a helix around the axis Z3. The internal tubular element 28 is fixed to the external tubular element 29, for example by means of welding or gluing, in such a way as to form the side wall 19 that acts as a single piece. When the internal tubular element 28 is fixed to the external tubular element 29, the channel 30 faces the further channel 31 and closes the further channel 31 so as to define a cooling conduit 32, that extends around the axis Z3 along a helicoidal path. Inside the cooling conduit 32 a cooling liquid, for example water, circulates in order to cool the internal surface 25 of the second transferring element 27.

It should be noted that the internal tubular element 28 is provided with a very reduced thickness, measured transversely to the axis Z3. This means that the cooling conduit 32 is near the internal surface 25, so as to cool it in an effective manner. The external tubular element 29 is much thicker than the internal tubular element 28, so as to give the second transferring element 27 good mechanical resistance.

The internal tubular element 28 can be made of metal material, for example steel, stainless steel or aluminium. These materials have good heat conductivity and enable the cooling liquid to cool the internal surface 25 effectively.

The second transferring element 27 is provided with an inlet conduit 33, through which the cooling liquid can enter the cooling conduit 32, and with a discharge conduit 34, through which the cooling liquid can exit from the cooling conduit 32 after cooling the second transferring element 27.

The inlet conduit 33 has a rectilinear shape and leads into the cooling conduit 32 near the lower opening 18. Also the discharge conduit 34 has a rectilinear shape and leads away from the cooling conduit 32 near the upper opening 16.

The lower opening 18 can be closed by means of a closing element 35 comprising a disc 36 arranged at an end of a lever 37. As shown in FIGS. 4 and 5, the lever 37 is connected, by means of a pivot 39, to a protrusion 38 that projects from the second arm 10. The lever 37 can rotate around the pivot 39 moving between a closed configuration, shown in FIGS. 4 and 6, and an open configuration, shown in FIGS. 5 and 7. In the closed configuration, the disc 37 is positioned at the lower opening 18, so as to shut it and prevent the dose 50 exiting from the second transferring element 27. In the open configuration, the disc 37 is positioned to the side of the lower opening 18, which is thus open and can be traversed by the dose 50 in order for the latter to enter the die 21. To pass from the open configuration to the closed configuration and vice versa, the closing element 35 is moved by a driving device that is not shown and moves by keeping itself on a plane that is substantially perpendicular to the axis Z3.

As shown in FIG. 9, the disc 36 comprises a base 40, adjacent to the lever 37, and a cover 42, arranged above the base 40. The cover 42 is bounded above by a transverse surface 43, that can be substantially flat, on which the dose 50 rests when the closing element 35 is located in the closed configuration. To prevent the dose 50 sticking to the transverse surface 43, the latter is cooled by a cooling liquid, for example water, in the manner disclosed below.

As is visible from FIG. 8, in which the cover 42 has not been shown, in the closing element 35 there is obtained an inlet conduit 44, which may be rectilinear, leading into a central region 45 of the base 40. The central region 45 has a substantially circular plan shape and from it a plurality of radial conduits 48 extend, said conduits being obtained by making in the base 40 a plurality of grooves 49 that are closed by the cover 42. The radial conduits 48 lead into a collecting conduit 51, having a shape that is substantially like that of a circular ring and defined by an annular groove 52, obtained in the base 40 and closed by the cover 42. From the collecting conduit 51 an outlet conduit 54 leads away, through which the cooling liquid can leave the closing element 35 after cooling the transverse surface 43.

During operation, just before the first portion T1, the closing element 35 is positioned in the closed configuration so as to close the lower opening 18 of the second transferring element 27. Along the first portion T1, a dose 50 coming from a superimposed first transferring element 101 enters the second transferring element 27 through the upper opening 16. Along the second path P2, the dose 50 drops by gravity inside the chamber 15 until it rests on the transverse surface 43, as shown in FIG. 6. Along the second portion T2, the closing element 35 reaches the open configuration and the dose 50 exits from the second transferring element 27 due to the force of gravity, passing through the lower opening 18, as shown in FIG. 7. The dose 50 then enters the die 21, that is not shown in FIG. 7.

The cooling liquid circulating in the second transferring element 27 prevents the dose 50 adhering to the surfaces of the second transferring element 27 with which it interacts, in particular to the internal surface 25 and to the transverse surface 43. In this way, the dose 50 can slide easily inside the second transferring element 27 and descend rapidly to the die 21.

The cooling liquid that cools the second transferring element 27, together with the relatively long time for which the second transferring element 27 remains superimposed on a corresponding die 21, enables the dose 50 to be transferred completely to the die 21 before the latter and the second transferring element 27 move away from one another. This makes the pistons disclosed in WO 03/047831 superfluous, the function of which was to rapidly expel the dose from the cylindrical chamber at the point in which the latter was superimposed on the die cavity.

In an embodiment that is not shown, the cooling liquid can cool the internal surface 25 traversing a cooling circuit that is different from the one shown in FIGS. 4 to 7. For example, instead of the cooling conduit 32 having a helicoidal shape, between the internal tubular element 28 and the external tubular element 29 there could be defined a cylindrical gap filled with the cooling liquid and extending around the axis Z3 substantially for the entire height of the second transferring element 27. Alternatively, between the internal tubular element 28 and the external tubular element 29 there could be obtained a plurality of cooling conduits that are equidistant and parallel to the axis Z3.

The side wall 19 could also be obtained in a single piece, in which case the cooling conduits could be obtained in the side wall 19 through known techniques.

Also the closing element 35 could have a distribution of the conduits that are traversable by the cooling liquid that is different from that shown in FIGS. 8 and 9. Further, instead of only a closing element 35, it is possible to provide two or more closing elements interacting between themselves to close and/or open the lower opening 18. If two or more closing elements are used, the transverse surface 43 may not be flat to give the dose 50 a desired shape, for example to thin an end of the dose in such a way that the dose enters a die 21 underneath more easily.

To ensure that along the first portion T1 and the second portion T2 the second path P2 coincides substantially respectively with the first path P1 and with the third path P3, it is possible to use arm devices that are different from those shown in FIG. 3. For example, in the embodiment in FIG. 10, the second transferring elements 27 are supported by a plurality of arm devices 141 according to an alternative embodiment. Each arm device 141 has two degrees of freedom with respect to the circular support 46. These two degrees of freedom are constrained respectively by a first controlling device and by a second controlling device that enable the position of the second transferring elements 27 to be defined univocally in each angular position of the circular support 46.

Each arm device 141 comprises a sleeve 55 that, near an internal end thereof, is pivoted on the circular support 46 by means of a pivot element 56. Inside the sleeve 55 there is positioned an arm 57 that supports at an external end thereof a second transferring element 27. The arm 57 is slidable with respect to the sleeve 55, which acts as a guide.

The movement of the sleeves 55 is controlled by the first controlling device, which comprises a first cam provided with a first track 111 in which a plurality of first rollers 112 engage, each of which is mounted on an appendage 58 of a sleeve 55. The second controlling device comprises a second cam having a second track 113, in which a plurality of second rollers 114 engage, each of which is mounted at an end of an arm 57 opposite the end that supports the second transferring element 27. When the circular support 46 is rotated, the first cam and the second cam ensure that the second transferring elements 27 move along the second path P2 in such a way as to travel along the first portion T1 and the second portion T2.

In a further alternative embodiment, shown in FIG. 11, the second transferring elements 27 are moved by a plurality of arm devices 241, each one of which comprises a first arm 206, a second arm 210 and a third arm 59. The first arm 206 has an end hinged on the circular support 46 and a further end, opposite the aforesaid end, pivoted on the second arm 210. The latter supports, at an external end thereof, a second transferring element 27.

The third arm 59 has an end pivoted on the circular support 46 and a further end, opposite the aforesaid end, pivoted on the second arm 210. The first arm 206, the second arm 210 and the third arm 59 define, together with the circular support 46, an articulated quadrilateral. The articulated quadrilateral has a single degree of freedom with respect to the circular support 46, and for fixing this degree of freedom a controlling device is provided comprising a cam provided with a track 61 arranged in a fixed position on the apparatus 1. In the track 61 a plurality of rollers 62 that are free to rotate engage, each of which can rotate around an axis along which the corresponding first arm 206 and second arm 210 are hinged together.

The track 61 enables the articulated quadrilateral to be moved in such a way that the second transferring elements 27 travel along the second path P2 having the first portion T1 in common with the first path P1 and the second portion T2 in common with the third path P3.

In a still further alternative embodiment, shown in FIG. 12, the second transferring elements 27 are supported by a plurality of arm devices 341 each one of which comprises an arm 357 supported by the circular support 46 and connected thereto by a connection having a single degree of freedom. In the example in FIG. 12, each arm 357 can rotate with respect to the circular support 46.

Each arm 357 supports, at an external end thereof, a second transferring element 27. Each arm 357 is furthermore slidable inside a sleeve 355 connected to the circular support 46. The arms 357 are controlled by a controlling device comprising a single cam, having a single track 361, in which a plurality of rollers 362 that are free to rotate engage, each one of which is mounted on an internal end of an arm 357. By choosing the track 361 appropriately, it is possible to ensure that the second transferring elements 27 move along the second path P2 comprising the first portion T1 in common with the first path P1 and the second portion T2 in common with the third path P3.

In the embodiments illustrated in FIGS. 3, 10, 11 and 12, the third path P3 of the dies 21 is circular and the second portion T2 is therefore also circular. Nevertheless, the third path P3 can have a different shape. For example, it may have a rectangular portion along which the second portion T2 is also determined. In this case, the centrifugal force acting on the dose 50 along the second portion T2 is substantially zero.

### Apparatuses and Method for Forming Objects

The invention relates to apparatuses and a method for forming objects, in particular for obtaining preforms of containers by compression-moulding doses of plastics.

WO 03/047831 discloses an apparatus for compression moulding of doses of plastics so as to obtain preforms, comprising a supply device for supplying molten plastics, a moulding device for compression moulding of doses of said molten plastics and a transferring carousel for transferring the doses from the supplying device to the moulding device.

The supplying device comprises a fixed plate in the thickness of which one or more conduits are obtained that take the plastics coming from a plasticising cylinder to a rotating joint. The transferring carousel is positioned above the fixed plate and can rotate around a vertical axis. The transferring carousel supports a plurality of cylindrical chambers that extend around respective vertical axes. Each cylindrical chamber is provided with an open lower end and with a piston that can run inside the chamber parallel to the axis of the latter.

When a cylindrical chamber passes above the fixed plate, a dose of plastics coming from the rotating joint enters the cylindrical chamber through the open lower end thereof and pushes upwards the piston housed in the cylindrical chamber. The latter is then moved by the rotatable carousel along a circular path until it is above a die cavity of the moulding device. When this occurs, the piston is driven downwards and pushes the dose outside the cylindrical chamber through the lower open end. The dose is thus deposited in the die cavity underneath.

The apparatus disclosed in WO 03/047831 further comprises heat conditioning means provided with thermostatic water cooling circuits that cools and controls the temperature of the walls of the cylindrical chamber and of the piston head. The thermal conditioning means enables the adhesion to the cylindrical chamber and to the piston of the plastics constituting the dose to be reduced.

A drawback of the apparatus disclosed in WO 03/047831 is that when a cylindrical chamber and an underlying die cavity move away from one another, the dose has not completely entered the die cavity. In fact, the dose can be transferred to the die cavity only when the cylindrical chamber inside which the dose is received is above the corresponding cavity, which occurs only at a point of the circular path of the cylindrical chamber. It is therefore possible, particularly when relatively large doses of the type used for moulding preforms are processed, that the dose is unable to descend completely into the die cavity in the short time in which the latter is below the cylindrical chamber. If this occurs, it is necessary to stop the apparatus to remove the dose that has not been transferred correctly.

In order to eliminate this drawback, in the apparatus according to WO 03/047831, slidable pistons were introduced inside the cylindrical chambers to push the doses outside the chambers. Nevertheless, this has entailed a significant complication in the apparatus, inasmuch as precise coupling is required between the pistons and the cylindrical chambers and a movement device that moves, at the correct moment, each piston.

Another drawback of the apparatus disclosed in WO 03/047831 is that the latter has rather a complicated structure that may have significant encumbrance. In fact, to house both the moulding device and the supplying device below the transferring carousel, it is necessary for the transferring carousel to have a great diameter, so as to prevent interference between the moulding device and the supplying device. To move a transferred carousel having a great diameter, it is nevertheless necessary to overcome forces of inertia. Further, large spaces have to be available for installing the apparatus.

An object of the invention is to improve the apparatuses and methods for forming objects, particularly by means of compression moulding of doses of plastics.

Another object is to make it easier to transfer the doses of plastics to forming means in which these doses are compression-moulded.

A further object is to decrease the overall dimensions of the apparatuses to form objects and to simplify the structure thereof.

A still further object is to reduce the force of inertia acting on the components of the apparatuses for forming objects.

In a first aspect of the invention, there is provided an apparatus comprising:
forming means that is movable along a path for compression moulding of doses of plastics;
transferring means for transferring said doses to said forming means;
liquid cooling means for cooling said transferring means;
   characterised in that it further comprises arm means associated with said transferring means for moving said transferring means along a further path having a portion substantially coinciding with a further portion of said path.

Owing to this aspect of the invention, a relatively long time is made available for transferring the doses from the transferring means to the forming means. In fact, the paths of the transferring means and of the forming means, rather than having a single point in common as in the prior art, have respectively substantially coinciding portions, along which the dose can be transferred to the forming means. This enables the risk to be reduced significantly that when the forming means and the transferring means move away from one another, the dose has not yet completely entered the forming means.

Further, owing to the liquid cooling means, it is possible to keep the temperature of the transferring means limited, which enables the adhesion of the dose to the transferring means to be limited. This reduces the amount of time that is necessary for the dose to pass from the transferring means to the forming means.

Owing to these solutions, it is possible to avoid using the pistons disclosed in WO 03/047831, which enables the structure of the apparatus to be simplified.

In a second aspect of the invention, there is provided an apparatus comprising:
forming means for compression moulding of doses of plastics;
transferring means for transferring said doses from delivery means to said forming means, said transferring means having a first opening and a second opening communicating together;
liquid cooling means for cooling said transferring means;
   characterised in that said delivery means and said forming means are positioned on opposite sides of said transferring means, so that said doses can enter said transferring means through said first opening and leave said transferring means through said second opening.

Owing to this aspect of the invention, it is possible to obtain an apparatus having a simple structure and limited overall dimensions. In particular, by positioning the delivery means and the forming means on opposite sides of the transferring means, a compact apparatus is obtained in which the dimensions of the transferring means can be reduced with respect to the known apparatuses. This also enables the forces of inertia acting on the transferring means to be reduced.

The liquid cooling means further enables the adhesion of the doses to the transferring means to be reduced.

In a third aspect of the invention, there is provided a method comprising:
receiving doses of plastics in transferring means cooled by a cooling liquid;
moving said transferring means for transferring said doses to a forming zone;
compression moulding said doses in said forming zone;
   characterised in that said doses enter said transferring means through a first opening and exit from said transferring means through a second opening that is distinct from said first opening.

Owing to the third aspect of the invention, it is possible to transfer the doses of plastics to the forming zone in a simple and compact manner.

The invention can be better understood and implemented with reference to the enclosed drawings, which illustrate some embodiments thereof by way of non-limitative example, in which:

FIG. 1 is a perspective view of a portion of an apparatus for compression moulding of doses of plastics;

FIG. 2 is a plan view of the apparatus in FIG. 1;

FIG. 3 is an enlarged and fragmentary view of arm means supporting transferring means in the apparatus in FIG. 2;

FIG. 4 is an enlarged plan view of the transferring means in FIG. 3, in a closed configuration;

FIG. 5 is a view like the one in FIG. 4, showing the transferring means in an open configuration;

FIG. 6 is a section taken along the plane VI-VI in FIG. 4;

FIG. 7 is a section like the one in FIG. 6, in the open configuration;

FIG. 8 is a plan view of a closing element of the transferring means in FIG. 4;

FIG. 9 is a section taken along the plane IX-IX of FIG. 8;

FIG. 10 is a plan view like the one in FIG. 3, showing an alternative embodiment of the arm means;

FIG. 11 is a plan view like the one in FIG. 3, showing a further alternative embodiment of the arm means;

FIG. 12 is a plan view like the one in FIG. 3, showing a still further alternative embodiment of the arm means.

With reference to FIGS. 1 and 2, there is shown an apparatus 1 for compression moulding of doses 50 of plastics so as to obtain objects, such as for example preforms for containers, particularly for bottles. The apparatus 1 comprises an extruding device 2 provided with a dispensing opening 8 through which the plastics are extruded along an outlet axis A arranged in an outlet direction Z1.

The apparatus 1 furthermore comprises cutting means 3 that cuts the plastics leaving the extruding device 2 to separate the doses 50 therefrom.

As shown in FIG. 1, the cutting means 3 is provided with a knife 22 comprising a blade 4 supported by a support element 5. The blade 4 has a substantially flat geometry and is provided with a cutting edge 53 with a substantially rectilinear shape, that lies on the plane defined by the blade 4. The knife 22 is rotated by means of rotating means 7 in such a way as to pass periodically below the extruding opening 8 to cut the plastics exiting from the extruding device 2.

Below the cutting means 3 transferring means 9 is provided for transferring the cut doses 50 from the cutting means 3 to forming means 17 comprising a plurality of moulds 20 mounted in a peripheral region of a moulding carousel 26. Each mould 20 comprises a die 21 and a punch, not shown, that are movable in relation to one another between an open position in which a dose 50 can be introduced inside the die 21 and a closed position in which the dose 50 is shaped so as to obtain a preform. The latter is extracted from the mould 20 by means of an extracting device 60.

The transferring means 9 comprises first transferring means 100 comprising a first carousel 23 that is rotatable around a rotation axis Z2. In a peripheral region of the first carousel 23 there is mounted a plurality of first transferring elements 101 each of which has a “C”-shaped cross section and is provided with a concavity in which a dose 50 can be received. Below this concavity there is provided a funnel element that is not shown, by means of which the dose 50 can be transferred to second transferring means 24 of the transferring means 9.

The second transferring means 24 comprises a plurality of second transferring elements 27 each of which has the shape of a hollow cylinder.

The first transferring elements 101 are movable along a first substantially circular path P1 along which each first transferring element 101 receives a dose 50 cut from the cutting means 3 in a removing position Q shown in FIG. 1. Whilst the first transferring element 101 moves along the first path P1, the dose 50 drops by gravity along the walls of the first transferring element 101 and after passing through the corresponding funnel element is delivered to a second transferring element 27.

The second transferring elements 27 are movable along a second path P2 that is at a lower level than the first path P1. The second path P2 is a closed and non circular loop path, in which it is possible to identify a first portion T1 in which the first path P1 is substantially coincident with the second path P2. Along the first portion T1, each first transferring element 101 moves by maintaining itself substantially superimposed on a corresponding second transferring element 27. In this way a relatively long period of time is made available in which the dose 50 contained in a first transferring element 101 can transfer into the corresponding second transferring element 27 due to the force of gravity.

After receiving the dose 50 from a superimposed first transferring element 101, each second transferring element 27 conveys the dose 50 along the second path P2 and releases it inside a die 21 underneath. The latter moves along a substantially circular third path P3 arranged at a lower level than the second path P2.

It is possible to identify a second portion T2 along which the second path P2 coincides substantially with the third path P3. In the second portion T2, each second transferring element 27 moves by maintaining itself substantially superimposed on a corresponding die 21. In this way a relatively long interval is made available during which the dose 50 can descend from the second transferring element 27 to the die 21 underneath. This ensures that the dose 50 is transferred completely into the die 21 before the latter moves away from the corresponding second transferring element 27.

In order to obtain the first portion T1 and the second portion T2, it is possible to provide a mechanism of the type shown in FIG. 3, comprising a circular support 46 that is rotatable around a shaft 47. The circular support 46 can be arranged on a horizontal plane, whilst the shaft 47 can be vertical on a fixed axis.

On the circular support 46 there is mounted a plurality of arm devices 41, each of which supports a respective second transferring element 27. Each arm device 41 is provided with two degrees of freedom with respect to the circular support 46 and, whilst it moves, is controlled by the first controlling means and by second controlling means that enable the two degrees of freedom to be locked and the position of each second transferring element 27 to be determined univocally for each angular position of the circular support 46.

In particular, according to the embodiment illustrated in FIG. 3, each arm device 41 comprises a first arm 6 and a second arm 10. The first arm 6 has an end pivoted on the circular support 46 and a further end pivoted on the second arm 10. The latter supports, at a free end thereof, a second transferring element 27.

The first controlling means acts on the first arms 6, whilst the second controlling means acts on the second arms 10. The first controlling means comprises a first cam having a first track 11, in which first driven means engages, comprising for example first rollers 12 carried by the first arms 6. Similarly, the second controlling means comprises a second cam having a second track 13, in which second driven means engages comprising for example second rollers 14 carried by the second arms 10. Owing to the first controlling means and to the second controlling means, the movement of the second transferring elements 27 during each revolution of the circular support 46 is defined univocally.

In particular, by suitably designing the first track 11 and the second track 13, it is possible to obtain the first portion T1 and the second portion T2 along the second path P2.

As shown in FIGS. 4 and 6, each second transferring element 27 is mounted at a free end of a corresponding second arm 10 and has a tubular shape, for example like a hollow cylinder. Each second transferring element 27 comprises a side wall 19 having an internal surface 25 that bounds a chamber 15 in which the dose 50 can be received. In the shown example, the chamber 15 has a substantially cylindrical shape and extends along a vertical axis Z3. The chamber 15 has an upper opening 16, by means of which a dose 50 can enter the chamber 15 from a first transferring element 101, and a lower opening 18, by means of which the dose 50 can exit the chamber 15 to be transferred to a die 21 underneath.

The side wall 19 comprises an internal tubular element 28 arranged inside an external tubular element 29. The internal tubular element 28 is bounded internally by the internal surface 25 and is provided externally with a channel 30 that extends in the shape of a helix around the axis Z3. Inside the external tubular element 29 there is obtained a further channel 31 that extends as a helix around the axis Z3. The internal tubular element 28 is fixed to the external tubular element 29, for example by means of welding or gluing, in such a way as to form the side wall 19 that acts as a single piece. When the internal tubular element 28 is fixed to the external tubular element 29, the channel 30 faces the further channel 31 and closes the further channel 31 so as to define a cooling conduit 32, that extends around the axis Z3 along a helicoidal path. Inside the cooling conduit 32 a cooling liquid, for example water, circulates in order to cool the internal surface 25 of the second transferring element 27.

It should be noted that the internal tubular element 28 is provided with a very reduced thickness, measured transversely to the axis Z3. This means that the cooling conduit 32 is near the internal surface 25, so as to cool it in an effective manner. The external tubular element 29 is much thicker than the internal tubular element 28, so as to give the second transferring element 27 good mechanical resistance.

The internal tubular element 28 can be made of metal material, for example steel, stainless steel or aluminium. These materials have good heat conductivity and enable the cooling liquid to cool the internal surface 25 effectively.

The second transferring element 27 is provided with an inlet conduit 33, through which the cooling liquid can enter the cooling conduit 32, and with a discharge conduit 34, through which the cooling liquid can exit from the cooling conduit 32 after cooling the second transferring element 27.

The inlet conduit 33 has a rectilinear shape and leads into the cooling conduit 32 near the lower opening 18. Also the discharge conduit 34 has a rectilinear shape and leads away from the cooling conduit 32 near the upper opening 16.

The lower opening 18 can be closed by means of a closing element 35 comprising a disc 36 arranged at an end of a lever 37. As shown in FIGS. 4 and 5, the lever 37 is connected, by means of a pivot 39, to a protrusion 38 that projects from the second arm 10. The lever 37 can rotate around the pivot 39 moving between a closed configuration, shown in FIGS. 4 and 6, and an open configuration, shown in FIGS. 5 and 7. In the closed configuration, the disc 37 is positioned at the lower opening 18, so as to shut it and prevent the dose 50 exiting from the second transferring element 27. In the open configuration, the disc 37 is positioned to the side of the lower opening 18, which is thus open and can be traversed by the dose 50 in order for the latter to enter the die 21. To pass from the open configuration to the closed configuration and vice versa, the closing element 35 is moved by a driving device that is not shown and moves by keeping itself on a plane that is substantially perpendicular to the axis Z3.

As shown in FIG. 9, the disc 36 comprises a base 40, adjacent to the lever 37, and a cover 42, arranged above the base 40. The cover 42 is bounded above by a transverse surface 43, that can be substantially flat, on which the dose 50 rests when the closing element 35 is located in the closed configuration. To prevent the dose 50 sticking to the transverse surface 43, the latter is cooled by a cooling liquid, for example water, in the manner disclosed below.

As is visible from FIG. 8, in which the cover 42 has not been shown, in the closing element 35 there is obtained an inlet conduit 44, which may be rectilinear, leading into a central region 45 of the base 40. The central region 45 has a substantially circular plan shape and from it a plurality of radial conduits 48 extend, said conduits being obtained by making in the base 40 a plurality of grooves 49 that are closed by the cover 42. The radial conduits 48 lead into a collecting conduit 51, having a shape that is substantially like that of a circular ring and defined by an annular groove 52, obtained in the base 40 and closed by the cover 42. From the collecting conduit 51 an outlet conduit 54 leads away, through which the cooling liquid can leave the closing element 35 after cooling the transverse surface 43.

During operation, just before the first portion T1, the closing element 35 is positioned in the closed configuration so as to close the lower opening 18 of the second transferring element 27. Along the first portion T1, a dose 50 coming from a superimposed first transferring element 101 enters the second transferring element 27 through the upper opening 16. Along the second path P2, the dose 50 drops by gravity inside the chamber 15 until it rests on the transverse surface 43, as shown in FIG. 6. Along the second portion T2, the closing element 35 reaches the open configuration and the dose 50 exits from the second transferring element 27 due to the force of gravity, passing through the lower opening 18, as shown in FIG. 7. The dose 50 then enters the die 21, that is not shown in FIG. 7.

The cooling liquid circulating in the second transferring element 27 prevents the dose 50 adhering to the surfaces of the second transferring element 27 with which it interacts, in particular to the internal surface 25 and to the transverse surface 43. In this way, the dose 50 can slide easily inside the second transferring element 27 and descend rapidly to the die 21.

The cooling liquid that cools the second transferring element 27, together with the relatively long time for which the second transferring element 27 remains superimposed on a corresponding die 21, enables the dose 50 to be transferred completely to the die 21 before the latter and the second transferring element 27 move away from one another. This makes the pistons disclosed in WO 03/047831 superfluous, the function of which was to rapidly expel the dose from the cylindrical chamber at the point in which the latter was superimposed on the die cavity.

In an embodiment that is not shown, the cooling liquid can cool the internal surface 25 traversing a cooling circuit that is different from the one shown in FIGS. 4 to 7. For example, instead of the cooling conduit 32 having a helicoidal shape, between the internal tubular element 28 and the external tubular element 29 there could be defined a cylindrical gap filled with the cooling liquid and extending around the axis Z3 substantially for the entire height of the second transferring element 27. Alternatively, between the internal tubular element 28 and the external tubular element 29 there could be obtained a plurality of cooling conduits that are equidistant and parallel to the axis Z3.

The side wall 19 could also be obtained in a single piece, in which case the cooling conduits could be obtained in the side wall 19 through known techniques.

Also the closing element 35 could have a distribution of the conduits that are traversable by the cooling liquid that is different from that shown in FIGS. 8 and 9. Further, instead of only a closing element 35, it is possible to provide two or more closing elements interacting between themselves to close and/or open the lower opening 18. If two or more closing elements are used, the transverse surface 43 may not be flat to give the dose 50 a desired shape, for example to thin an end of the dose in such a way that the dose enters a die 21 underneath more easily.

To ensure that along the first portion T1 and the second portion T2 the second path P2 coincides substantially respectively with the first path P1 and with the third path P3, it is possible to use arm devices that are different from those shown in FIG. 3. For example, in the embodiment in FIG. 10, the second transferring elements 27 are supported by a plurality of arm devices 141 according to an alternative embodiment. Each arm device 141 has two degrees of freedom with respect to the circular support 46. These two degrees of freedom are constrained respectively by first controlling means and by second controlling means that enable the position of the second transferring elements 27 to be defined univocally in each angular position of the circular support 46.

Each arm device 141 comprises a sleeve 55 that, near an internal end thereof, is pivoted on the circular support 46 by means of a pivot element 56. Inside the sleeve 55 there is positioned an arm 57 that supports at an external end thereof a second transferring element 27. The arm 57 is slidable with respect to the sleeve 55, which acts as a guide.

The movement of the sleeves 55 is controlled by the first controlling means, which comprises a first cam provided with a first track 111 in which a plurality of first rollers 112 engage, each of which is mounted on an appendage 58 of a sleeve 55. The second controlling means comprises a second cam having a second track 113, in which a plurality of second rollers 114 engage, each of which is mounted at an end of an arm 57 opposite the end that supports the second transferring element 27. When the circular support 46 is rotated, the first cam and the second cam ensure that the second transferring elements 27 move along the second path P2 in such a way as to travel along the first portion T1 and the second portion T2.

In a further alternative embodiment, shown in FIG. 11, the second transferring elements 27 are moved by a plurality of arm devices 241, each one of which comprises a first arm 206, a second arm 210 and a third arm 59. The first arm 206 has an end hinged on the circular support 46 and a further end, opposite the aforesaid end, pivoted on the second arm 210. The latter supports, at an external end thereof, a second transferring element 27.

The third arm 59 has an end pivoted on the circular support 46 and a further end, opposite the aforesaid end, pivoted on the second arm 210. The first arm 206, the second arm 210 and the third arm 59 define, together with the circular support 46, an articulated quadrilateral. The articulated quadrilateral has a single degree of freedom with respect to the circular support 46, and for fixing this degree of freedom controlling means is provided comprising a cam provided with a track 61 arranged in a fixed position on the apparatus 1. In the track 61 a plurality of rollers 62 that are free to rotate engage, each of which can rotate around an axis along which the corresponding first arm 206 and second arm 210 are hinged together.

The track 61 enables the articulated quadrilateral to be moved in such a way that the second transferring elements 27 travel along the second path P2 having the first portion T1 in common with the first path P1 and the second portion T2 in common with the third path P3.

In a still further alternative embodiment, shown in FIG. 12, the second transferring elements 27 are supported by a plurality of arm devices 341 each one of which comprises an arm 357 supported by the circular support 46 and connected thereto by a connection having a single degree of freedom. In the example in FIG. 12, each arm 357 can rotate with respect to the circular support 46.

Each arm 357 supports, at an external end thereof, a second transferring element 27. Each arm 357 is furthermore slidable inside a sleeve 355 connected to the circular support 46. The arms 357 are controlled by controlling means comprising a single cam, having a single track 361, in which a plurality of rollers 362 that are free to rotate engage, each one of which is mounted on an internal end of an arm 357. By choosing the track 361 appropriately, it is possible to ensure that the second transferring elements 27 move along the second path P2 comprising the first portion T1 in common with the first path P1 and the second portion T2 in common with the third path P3.

In the embodiments illustrated in FIGS. 3, 10, 11 and 12, the third path P3 of the dies 21 is circular and the second portion T2 is therefore also circular. Nevertheless, the third path P3 can have a different shape. For example, it may have a rectangular portion along which the second portion T2 is also determined. In this case, the centrifugal force acting on the dose 50 along the second portion T2 is substantially zero.

1-59. (canceled)

60. Apparatus comprising:
a forming arrangement for compression moulding of doses of plastics;
a transferring device for transferring said doses from a delivery device to said forming arrangement, said transferring device having a first opening and a second opening communicating together;
a liquid cooling arrangement for cooling said transferring device;
wherein said delivery device and said forming arrangement are positioned on opposite sides of said transferring device, so that said doses can enter said transferring device through said first opening and exit from said transferring device through said second opening.

61. Apparatus according to claim 60, wherein said first opening and said second opening are superimposed on one another.

62. Apparatus according to claim 60, wherein said first opening is positioned in an upper region of said transferring device and said second opening is positioned in a lower region of said transferring device.

63. Apparatus according to claim 60, wherein said transferring device is movable on an intermediate plane which is interposed between a first plane on which said forming arrangement is movable and a second plane on which said delivery device is movable.

64. Apparatus according to claim 63, wherein said first plane is arranged below said second plane.

65. Apparatus according to claim 60, wherein said liquid cooling arrangement comprises a circulation arrangement arranged near an internal side surface of said transferring device and traversable by a cooling liquid for cooling said internal side surface.

66. Apparatus according to claim 65, wherein said circulation arrangement comprises a spiral conduit surrounding said internal side surface.

67. Apparatus according to claim 66, and further comprising an inlet conduit leading into a lower region of said spiral conduit and a discharge conduit leaving an upper region of said spiral conduit.

68. Apparatus according to claim 66, wherein said transferring device comprises a first component outside which there is provided a first channel and a second component inside which there is provided a second channel, said first channel facing said second channel to define said spiral conduit.

69. Apparatus according to claim 60, wherein said liquid cooling arrangement comprises a circuit arranged near a lower internal surface of said transferring device and traversable by a coolant liquid for cooling said lower internal surface.

70. Apparatus according to claim 69, wherein said circuit comprises an inlet zone for said coolant liquid, a collecting zone of said coolant liquid and a plurality of conduits connecting said inlet zone with said collecting zone.

71. Apparatus according to claim 70, wherein said inlet zone has a substantially circular shape and the conduits of said plurality of conduits lead away radially from said inlet zone.

72. Apparatus according to claim 71, wherein said collecting zone comprises an annular conduit that is substantially concentric with said inlet zone.

73. Apparatus according to claim 70, and further comprising an outlet conduit exiting from said collecting zone.

74. Apparatus according to claim 69, wherein said lower internal surface is obtained on a closing element movable between an open configuration and a closed configuration for opening and/or closing said transferring device.

75. Apparatus according to claim 70, wherein said transferring device comprises at least a tubular element.

76. Apparatus according to claim 60, wherein said forming arrangement is mounted on a moulding carousel rotating in a continuous manner.

77. Apparatus according to claim 60, wherein said forming arrangement comprises a die device and a punch device interacting together to form preforms of containers from said doses.

78. Method comprising:
receiving doses of plastics in a transferring device cooled by a cooling liquid;
moving said transferring device for transferring said doses to a forming zone;
compression moulding said doses in said forming zone;
wherein said doses enter said transferring device through a first opening and exit said transferring device through a second opening distinct from said first opening.

79. Method according to claim 78, wherein said doses move in said transferring device descending from said first opening to said second opening.

80. Method according to claim 79, wherein said doses descend into said transferring device only due to the force of gravity.
